(19) United States
(12) Patent Application Publication
(10) Pub. No.: US 2022/0357260 A1
(43) Pub. Date: Nov. 10, 2022

(54) DEVICE AND METHOD FOR VISCOSITY OR VISCOELASTICITY MEASUREMENT

(71) Applicant: Jürgen SANDERS, Vila Nova De Gaia (PT)

(72) Inventor: Jürgen SANDERS, Vila Nova De Gaia (PT)

(21) Appl. No.: 17/778,845

(22) PCT Filed: Nov. 24, 2020
(86) PCT No.: PCT/IB2020/061097

§ 371 Date: May 22, 2022

(30) Foreign Application Priority Data
Nov. 29, 2019 (PT) 115943

(51) Int. Cl. G01N 11/14

(52) U.S. Cl. CPC G01N 11/14; G01N 2011/008

(57) ABSTRACT

The present disclosure relates to a device for viscosity or viscoelasticity measurement comprising: a structure comprising a horizontal rotatable cylinder-shaped section for receiving a liquid whose viscosity or viscoelasticity is to be measured; a light source arranged for emitting light onto the liquid surface in rotation within said structure; an optical focusing screen arranged at an end of said cylinder-shaped section; an optical sensor for detecting a light spot, emitted by the light source and reflected by the liquid surface in rotation within the structure, impinging on the optical focusing screen; an electronic data processor arranged for calculating the viscosity or viscoelasticity of the liquid from the location of said light spot on said optical focusing screen. The present disclosure also relates to a method of manufacture of the device and a method for measuring viscosity or viscoelasticity of a liquid.

### TECHNICAL FIELD

The invention describes a device and method for measuring viscoelastic properties of liquids and relates to the field of rheometry, in particular to the field of fluid mechanics.

Viscoelastic liquids are characterized by their viscous and elastic properties. Typically, these properties depend on the speed or frequency of excitation and they vary with temperature. An example of a viscoelastic liquid may be a thick polymer solution, where long polymer chains induce a certain amount of elasticity while the solvent assures that the solution can flow like a liquid. In fast motions, or at higher frequencies, the elastic properties dominate the response, while in slow motions, or at lower frequencies, the viscous properties dominate.

### BACKGROUND

Viscoelastic properties of a given material can be observed, in principle, by any imposed movement on a sample.

In the art, it is most common to determine the viscoelastic properties of a material sample by measuring the relaxation response after a sudden step-motion or by means of the amplitude and phase response to an imposed mechanical oscillation.

It is also common to measure the torque amplitude and phase in an oscillating cone and plate viscometer, also called “rheometer”. The amplitude and phase measurements determine material parameters which can be represented in the linear range for liquids by the so-called “complex viscosity”. Normally, the complex viscosity varies with the frequency of excitation and with temperature.

Cone and plate viscometers need very small liquid samples, usually a few drops, offer a wide range of measurement frequencies, and a straightforward theoretical interpretation.

Some disadvantages of cone and plate viscometers are the requirement for sensitive torque measurements, friction of the mechanical bearings, uncertain flow conditions at the outer edge of the cone and plate, the need for a precise adjustment of the gap width between the cone and the plate, difficult temperature control, and flow instabilities especially for larger gap widths and for liquids containing material impurities.

More relevant to the proposed invention is the determination of the same viscoelastic properties from measuring the free surface shape of rimming flow of a liquid inside a horizontal rotating cylinder. This was demonstrated in 1981 in theory and by measurements [1]. At that time, the shape of the liquid free surface was determined from the light absorbed by the liquid between the inner and outer liquid surface. The light was passed from within the cylinder onto a photodiode glued on the outside of a transparent horizontal rotatable cylinder. The measurement resulted from the thickness of the liquid over the circumference of the cylinder.

In [1], for preparing the measurement, the cylinder was first rotated at a very fast rotation such that the centrifugal force dominates, pressing the liquid from the inside onto the cylinder walls at uniform thickness in a near rigid motion. Then, at subsequently reduced lower rotational speed the liquid gets affected by gravity, letting it flow relative to the rotational direction of the cylinder. This is also called “rimming flow”. Phase and amplitude of this flow, or of the resulting thickness of the liquid as a function of the rotational angle φ, allow determining the viscoelastic properties and the complex viscosity.

In Sanders et al. [1], the rotatable cylinder was 60.5 cm long with an inner diameter of 6.45 cm, liquid thickness was up to 2 cm, rotation speeds were from 0.25 to 10 rotations per second, and the liquids tested had shear viscosities between 120 to 200 Poise. The present invention developed a very different device as it is herein disclosed.

Measuring the liquid thickness around the circumference near the middle of the rotating horizontal cylinder by the light absorbed from the liquid can deliver very accurate results. But this method of measuring viscoelastic properties in rimming flow was not pursued further, probably because of a number of drawbacks limiting its practicality. Some of these drawbacks were the need for adding paint pigments to the liquid to make it light absorbing; the need for calibrating the light absorption coefficient; the difficulty of passing the electrical signal from the rotating photodiode; the need to bring the light source physically inside the horizontal rotating cylinder, and for the latter reason the difficulty for controlling the temperature.

### GENERAL DESCRIPTION OF THE INVENTION

The proposed invention refers to an optical device applied to rimming flow of viscoelastic liquids inside a horizontal rotating cylinder for determining viscoelastic properties of the liquid.

The invention proposes an optical device for measurement of the free surface of a liquid in rimming flow inside a horizontal rotatable cylinder. The measurement allows determining the viscoelastic properties of the liquid.

Viscoelastic liquids are a common form of non-Newtonian liquids. They can exhibit a response that resembles that of an elastic solid under some circumstances, or the response of a viscous liquid under other circumstances. Typically, liquids that exhibit this behavior are macromolecular in nature (that is, they have high molecular weight), such as polymeric liquids (melts and solutions) used to make plastic articles, food systems such as dough used to make bread and pasta, and biological liquids such as synovial liquids found in joints, and lubricants.

The macromolecular nature of polymeric molecules along with physical interactions called entanglements lead to the elastic behavior (the liquids resemble a mass of live worms). Deformed molecules are driven by thermal motions to return to their undeformed states, giving the bulk fluid elastic recovery. Properties of polymeric fluids have a direct influence on the processing behavior and in some cases on the performance of the polymer in a given application.

An example of a viscoelastic liquid may be a polymer solution where long polymer chains induce a certain amount of elasticity while the solvent assures that the solution can flow like a liquid. In fast motions, or at higher frequencies, the elastic properties dominate, while in slow mentions, or at lower frequencies, the viscous properties dominate. Both, the amount of viscosity and the amount of elasticity are not contestant values, but depend on the frequency of excitation. This is why, for a given liquid, and at otherwise constant conditions, the characterizing “complex viscosity” is not a constant value, but can be represented as two separate functions of the excitation frequency. In the embodiment of this disclosure, the excitation frequency is given by the action of gravity on the rotating liquid particle, gravity acting on each liquid particle at the frequency given by the rotation speed of the horizontal rotating cylinder. Measurements are normally taken over a range of excitation frequencies or, in an embodiment of this disclosure, over a range of rotation speeds.

The viscoelastic properties of a liquid depend on the speed of excitation. An example of a viscoelastic liquid may be a polymer solution, where long polymer chains induce a certain amount of elasticity while the solvent assures that the solution can flow like a liquid. In fast motions, or at higher frequencies, the elastic properties dominate, while in slow motions, or at lower frequencies, the viscous properties dominate.

In an embodiment, in rimming flow of viscoelastic liquids inside of a horizontal rotatable cylinder, the excitation comes from gravity and the frequency is imposed by the rotational speed. The inner free surface of the liquid remains nearly circular over a wide range of rotation speeds, forming an open annulus around the axis of the horizontal rotatable cylinder. With decreasing rotation speed, gravity moves the center axis of the liquid free surface away from the axis of the rotatable cylinder. Measuring the distance amplitude and phase angle between these two axes allows to determine the viscoelastic property of the liquid.

In an embodiment, for liquids of which their free surface reflects light (most liquids), a fixed light source placed on or near the rotation axis of the horizontal rotating cylinder shines on the liquid free surface. The light source may be at one end of the cylinder and it can be outside of the cylinder itself. The light reflected from the liquid surface will focus on a focusing screen placed at the other end of the cylinder. The shifted position of the focused image from the light source reveals the exact shifted position of the liquid center where the light is reflected on the liquid surface, i.e. in the middle between the light source and the focusing screen (see FIG. 2). Using a point source would be convenient, but any light source is within the scope of the present disclosure, as long as the beam opening reaches the liquid surface in the position where it is to be measured.

In an embodiment, the image is focused on a focusing screen, directly on the camera screen, a Position Sensing Detector (PSD), a quadrant photodiode, or similar.

The proposed device measures the position of the liquid free surface of rimming flow inside of a horizontal rotating cylinder. The device consists of the said horizontal rotatable cylinder, a light source placed at one end of the cylinder and an optical focusing screen placed at the other end of the cylinder, such that the light enters the open annulus that forms inside the rotating liquid, reflects on the inner free surface of this liquid and produces an image of the light source on the optical focusing screen. The image on the optical focusing screen moves at twice the distance of the movement of the liquid free surface, thus revealing the position of the liquid free surface inside of the cylinder at about half distance between the light source and the optical focusing screen.

Advantages of measuring viscoelasticity in a horizontal rotatable cylinder are: increasing the measurement accuracy, measuring a wider range of possible liquids, obtaining better temperature control, using larger liquid samples, and under certain conditions it may be possible to achieve higher measurement sensitivities.

In an embodiment, the present disclosure refers specifically to a horizontal rotating partially liquid filled cylinder of short length as a new device for measuring viscoelastic properties of the liquid. In particular, the shape of the liquid surface near the middle of the cylinder axis, or the thickness of the liquid at different angular positions φ, its amplitude and phase, represent the viscoelastic response and can be used to determine the viscoelastic parameters of the liquid. Typical measured parameters are the amplitude and phase angle over a range of circular frequencies (or rotational speeds) ω.

The cylinder must rotate around its horizontal length axis at sufficient speed such that the liquid adheres to the inner wall of the cylinder forming a circular or near-circular inner free surface leaving a sufficiently wide annular open space around the rotation axis of the cylinder.

In an embodiment, the horizontal rotatable cylinder is designed to obstruct the liquid from flowing out at each of the cylinder's ends for as long as the cylinder rotates at sufficient speed. Both ends of the horizontal cylinder allow light to pass through by being, in an embodiment, partially open or transparent.

The light goes from the light source at one end, reflects on the liquid surface approximately in the middle of the light path, and focusses on the optical focusing screen which is placed at the opposite end of the cylinder. Two light paths are indicated in FIG. 4 for two different positions of the liquid free surface. It follows directly from the geometry that the focusing position of the image emitted from the light source moves on the optical focusing screen at twice the distance A of the liquid surface, in the direction of the phase angle cp.

In an embodiment, the mounting of the cylinder on or within a frame of rollers is proposed for short cylinders (see FIG. 5) instead of the usual mount with two ball bearings along the axis on each end of the cylinder. A main advantage of using rollers is a shorter assembly, as in this embodiment the optical measurement systems is placed close to the cylinder end-pieces. Another main advantage is that the cylinder can be easily moved in and out of the assembly by simply placing it onto the rollers or lifting it from them.

A particularly preferred embodiment of the present disclosure is a device for viscosity or viscoelasticity measurement comprising:
a structure comprising a horizontal rotatable cylinder-shaped section for receiving a liquid whose viscosity or viscoelasticity is to be measured;
a light source arranged at a first end of said structure for emitting light onto the liquid surface in rotation within said structure;
an optical focusing screen arranged at a second end of said structure;
an optical sensor for detecting a light spot, emitted by the light source and reflected by the liquid surface in rotation within the structure, and re-focusing on the optical focusing screen;
an electronic data processor arranged for calculating the viscosity or viscoelasticity of the liquid from the location of said light spot on said optical focusing screen.

In an embodiment, a horizontal rotatable cylinder is placed in its length direction between the light source and the optical focusing screen such that the cylinder can rotate around its axis.

In an embodiment, the cylinder contains the sample liquid which forms a free inner circular surface when the cylinder is rotated at sufficient speed, and the cylinder allows the light from the light source to pass through to reflect on the liquid surface and refocus on the optical focusing screen.

In a preferred embodiment it is disclosed a device for viscosity or viscoelasticity measurement comprising:

a structure comprising a horizontal rotatable cylinder-shaped section for receiving a liquid whose viscosity or viscoelasticity is to be measured;
a light source arranged for emitting light onto the liquid surface in rotation within said structure;
an optical focusing screen arranged at an end of said cylinder-shaped section; an optical sensor for detecting a light spot, emitted by the light source and reflected by the liquid surface in rotation within the structure, impinging on the optical focusing screen;
an electronic data processor arranged for calculating the viscosity or viscoelasticity of the liquid from the location of said light spot on said optical focusing screen.

In a particular embodiment, the structure is placed lengthwise between the light source and the optical screen.

In a further embodiment, the light source is movable for adjusting the light path during the measurement.

In a further embodiment, the screen is an optical focusing screen, preferably a screen with a camera, more preferably an electronic camera, a CCD sensor, a CMOS sensor, a quadrant photodiode or a position sensing detector (PSD).

In a further embodiment, the device further comprises a light block for avoiding the light emitted by the light source to impinge directly on the optical screen directly.

In a further embodiment, a inner surface of said structure comprises an antioxidant and/or antimicrobial coating.

In a further embodiment, the device further comprises a concave lens in front of the optical focusing screen for amplification of the optical signal.

In a further embodiment, the light source is selected from the following list: incandescent lamp, compact fluorescent lamp, halogen lamp, metal halide lamp, light emitting diode, fluorescent tube, neon lamp, high intensity discharge lamp, low-pressure sodium lamp and diode laser, preferably a miniature diode laser with a concave or convex expanding lens.

In a further embodiment, the structure is made of poly(methyl methacrylate), ceramics, glass, hard plastic, steel or combinations thereof.

In a further embodiment, the structure has an inner diameter from 40 mm to 300 mm, preferably from 60 mm to 150 mm, particularly 64 mm.

In a further embodiment, the structure has an outer diameter from 50 mm to 320 mm, preferably from 65 mm to 150 mm, particularly 70 mm.

In a further embodiment, the structure has a length from 30 to 1000 mm, preferably from 100 mm to 200 mm, particularly 150 mm.

In a further embodiment, the device further comprises an outer case around the horizontal rotatable cylinder for maintaining the temperature during viscosity or viscoelasticity measurement.

In a further embodiment, the outer case is a heat shield.

In a further embodiment, the device further comprises a supporting structure, particularly a rolling structure or a fixed structure.

In a further embodiment, the supporting structure comprises a roller or a plurality of rollers.

In a further embodiment, the supporting structure comprises a bearing or a plurality of bearings.

In a further embodiment, the supporting structure comprises ball bearings around the horizontal cylinder, sliding bearings, or a plurality of bearings supporting the horizontal cylinder.

It is also disclosed a method of manufacture of a device comprising the step of providing a device.

It is also disclosed a method for measuring viscosity or viscoelasticity of a liquid comprising the following steps:

placing a light source arranged at a first end of said structure for emitting light onto the liquid surface in rotation within the structure;
placing an optical focusing screen arranged at a second end of said structure;
introducing a liquid in a structure comprising a horizontal rotatable cylinder-shaped section;
rotating said structure at a speed such that a quasi-cylindrical surface of liquid is formed;
detecting a light spot, emitted by the light source and reflected by the liquid surface in rotation within said structure, impinging on the optical focusing screen;
calculating the viscosity or viscoelasticity of the liquid from the location of said light spot on said optical focusing screen.

In a further embodiment, the method comprises the steps of:

detecting multiple light spots or a multiple light-spot image, emitted by the light source and reflected by the liquid surface in rotation within said structure, impinging on the optical screen;
calculating the viscosity or viscoelasticity of the liquid from the location of said light spots or said multiple light spots on the image on said optical screen.

It is also disclosed a method for measuring viscosity or viscoelasticity of a liquid comprising the following steps:

placing a light source arranged at a first end of said structure for emitting light onto the liquid surface in rotation within the structure;
placing an optical focusing screen arranged at a second end of said structure; introducing a first liquid in a structure comprising a horizontal rotatable cylinder-shaped section;
introducing a second liquid in said structure such that the horizontal rotatable cylinder is completely filled;
rotating said structure at a speed such that a quasi-cylindrical surface between the first liquid and second liquid is formed;
detecting a light spot, emitted by the light source and reflected by the surface between the first liquid and second liquid in rotation within said structure, impinging on the optical focusing screen;
calculating the viscosity or viscoelasticity of the first liquid from the location of said light spot on said optical focusing screen.

In a further embodiment, the method comprises the steps of:

detecting multiple light spots or a multiple light-spot image, emitted by the light source and reflected by the surface between the first liquid and second liquid in rotation within said structure, impinging on the optical screen;
calculating the viscosity or viscoelasticity of the liquid from the location of said light spots or said multiple light spots on the image on said optical screen.

In a further embodiment, the calculation is performed on an electronic data processor.

In a further embodiment, the liquid is selected from the following list: liquid with no impurities, liquid with impurities, liquid with inhomogeneities, liquid with dirt particles, liquid with nanoparticles and mixtures thereof.

It is also disclosed, depending on the characteristics of the liquid, it is hereby considered to measure the position of the liquid surface by a standard laser triangulation sensor. This would be especially suitable for liquids that are not transparent and with a non-reflective liquid surface. A standard laser triangulation sensor can be placed at one end of the cylinder of the present disclosure (see FIG. 6). By means of a mirror or prism placed inside the cylinder, the laser would illuminate the liquid surface at the measurement position. The triangulation sensor measures the height position of the illuminated liquid surface. Rotating the sensor and the mirror allows measuring the liquid surface height position at any angle cp. Such triangulation sensors, which contain the laser, a focusing lens, the sensor and evaluation electronics can be purchased at appropriate dimensions.

### BRIEF DESCRIPTION OF DRAWINGS

FIG. 1—Liquid with free surface 101 inside the horizontal rotating cylinder. The cylinder is rotating at a speed ω, the surface position r(φ) is a function of the angle cp.

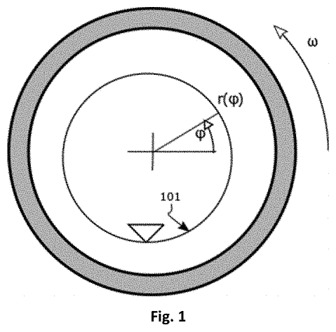

FIG. 2—Light reflects on the liquid surface 201 inside the partially filled horizontal rotating cylinder. The position of the image on the focusing screen 203 moves with the centre position of the circular (or nearly circular) liquid surface at a horizontal position between the light source 202 and the focusing screen 203.

FIG. 3—Movement of the free surface of the liquid, looking into the direction of the rotation axis. The horizontal rotating cylinder 301 contains the liquid with the free surface which is concentric to the cylinder at fast rotation as indicated in 302. Reducing the rotation speed the liquid surface moves, as indicated for an example in 303. The amplitude A and the phase angle φ of this move are directly related to the viscoelastic properties of the liquid.

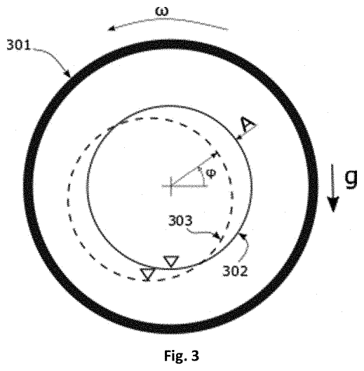

FIG. 4—Arrangement of the device in a sideview onto the horizontal rotating cylinder. The view is cut in the direction that shows the maximum amplitude A of the distance that the liquid surfaces would have at two different rotational speeds. The horizontal rotating cylinder 401 contains the sample liquid. The cylinder is filled such that in fast rotation the liquid forms a concentric free circular surface 402. At reduced rotation speed this free surface takes a different position as indicated in 403. The light goes from the light source 404 at one end, reflects on the liquid surface approximately in the middle of the light path, and re-focusses on the optical focusing screen 405 which is placed at the opposite end of the cylinder. Two light paths are indicated in the figure as 406 and 407 for two different positions of the liquid free surface. It follows from the geometry that the focusing position of the image emitted from the light source moves on the optical focusing screen at twice the distance A of the liquid surface, in the direction of the phase angle φ.

FIG. 5—Mounting the horizontal rotatable cylinder on motor-driven rollers 504 and with a surrounding heat shield 506. The horizontal rotatable cylinder with the test liquid and the free surface 501 can be encapsulated inside the heat shield. The motor 505, the light source 502 and the focusing screen 503 can remain outside of the heat shield 506.

FIG. 6—Standard laser triangulation sensor 604 for measuring the height position of the liquid free surface 602 for all angles φ inside of the horizontal rotating cylinder that is rotating at speed ω. The light path 606 from the laser 605 is reflected by a mirror or a prism 603, marking the position of the surface. The position is measured on the sensor that is inside the standard laser triangulation sensor. The non-standard application of the laser triangulation sensor 604 is considered by a correction factor that results from the particular geometry.

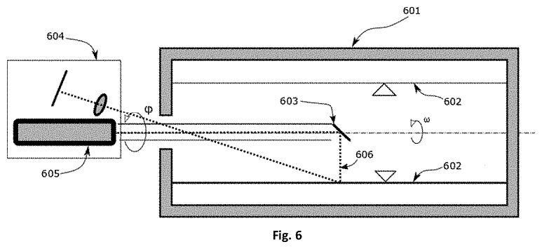

### DETAILED DESCRIPTION OF THE INVENTION

The proposed device is a horizontal rotatable cylinder with a light source placed at one end of the cylinder and a focusing screen placed at the other end of the cylinder.

The cylinder is rotatable around its natural rotation axis.

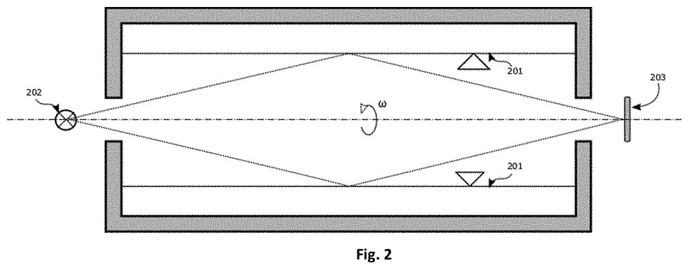

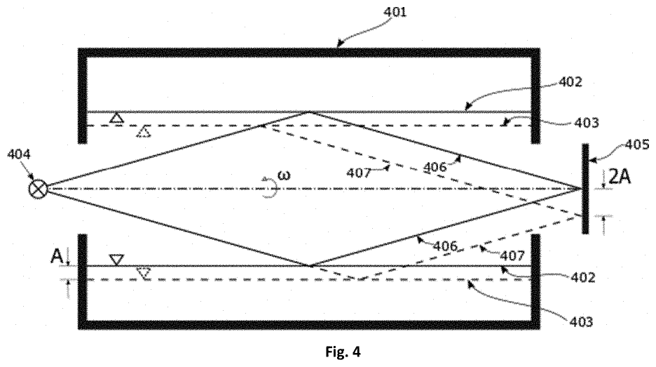

In an embodiment the cylinder contains the liquid sample. The end pieces of the cylinder must keep the liquid from flowing out of the cylinder when the cylinder rotates at sufficient speed. The end pieces of the cylinder must also allow the light to enter into and out of the cylinder. Therefore, the end pieces must either be transparent to light of they must be open near the rotational axis of the cylinder as indicated in FIG. 2 and FIG. 4.

In an embodiment the liquid sample is in quantity such that it fills the cylinder partially. The cylinder is rotatable at sufficient speed so that the liquid adheres to the inner wall of the cylinder, rotating with the cylinder and forming a circular or near-circular inner free surface leaving an annual open space around the rotation axis of the cylinder.

In an embodiment the light source is placed at or near the rotation axis of the cylinder. It is convenient to place the light source at a certain small distance outside of the cylinder. The light source emits a light cone sufficiently large to reflect on the entire liquid inner surface near the middle of the cylinder as indicated in FIG. 2 and FIG. 4.

In an embodiment the focusing screen is placed at the other end of the cylinder, pointing towards the cylinder's rotational axis to capture the light reflected from the liquid surface.

At high rotation speeds, the liquid is in a near rigid rotation due the predominance of centrifugal forces. Measurements are performed at lower speeds, when gravity affects the liquid flow and the liquid free surface remains circular or nearly circular, but ceases to be concentric with the axis of the cylinder. The image of the light source reflects on the liquid free surface and focusses on the focusing screen. The image moves at exactly twice the distance moved by the liquid surface. The shape of the liquid surface is thus measured from the image on the focusing screen. The shape of the liquid surface is thus measured at or near the middle position between the light source and the focusing screen, which is about in the middle between the two end-pieces of the cylinder. It is an advantage thus determining the surface position of the liquid distant from the end-plates, minimizing the effect that the end plates have on the flow field.

The algorithm for deducing the viscoelastic properties from the measured position of the liquid surface is the same as for the infinitely long cylinder, when considering the uncertainty due the influence of the end-pieces on the liquid flow. In this case, the two parameters of the liquid free surface used for the evaluation are the amplitude A and the phase angle φ of this amplitude relative to the direction of gravity. It is also possible to consider the complete 3D flow field in the given geometry.

Surprisingly, the disclosure uses a cylinder of short length, the length being typically up to four times of its diameter or less. The main advantage of using a short cylinder is that the shape of the liquid surface can be measured by optical methods which are not applicable for cylinders which are very long.

In an embodiment, a convenient choice for the light source is using point source of light. In good approximation this is generated with a diode laser with a concave or convex expanding lens. The image on the optical focusing screen results in a distinct single focus point. The position of this focus point can be determined by taking the maximum point of light intensity. It is, however, determined at greater accuracy when considering all reflected light rays around the focus point and matching the complete image on the screen to the image calculated for the respective geometry. This is similar, but slightly more complex, for a larger light source. Therefore, choosing a point source is a convenient choice, but it is not the only choice within the scope of the present invention.

In an embodiment, the device includes blocking the part of the light that may shine from the light source to the optical focusing screen directly. This part of the light is to be considered when interpreting the image on the optical focusing screen. It is not significant in comparison to part of light reflected on the liquid surface, but it is still advantageous to block the direct light transmission from source to screen.

In an embodiment, the image on the optical focusing screen is recorded by a camera, but instead of a distinct optical focusing screen, with a separate camera, the optical focusing screen is a device that records the image directly like an image sensor, a CCD sensor, a CMOS sensor, a quadrant photodiode, a Position Sensing Detector (PSD), or a camera with a suitable optics.

In a further embodiment, placing a concave lens in front of the optical focusing screen amplifies the amplitude signal, increasing the sensitivity.

In a further embodiment, the light source is fixed or movable.

In a further embodiment, the light source is movable for adjusting the light path during the measurement. One convenient choice is to track with the position of the light source the central axis of the rotating liquid surface. An equivalent solution is to move the light source in the same way in the x-y-direction as the light spot moves on the optical focusing screen, the z-direction being that of the rotation axis of the horizontal rotating cylinder. Another convenient choice is, when using a point source, controlling its x-y-position of the light source such to form a concentric image on the focusing screen.

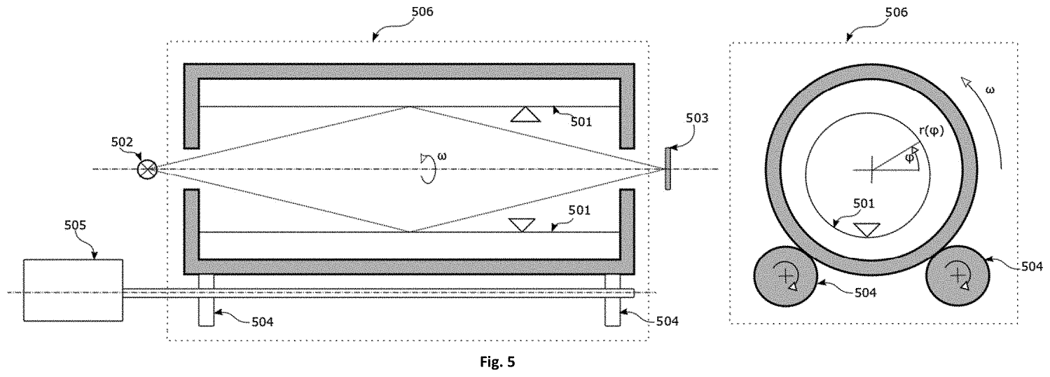

In a further embodiment, the optical measurement allows a complete thermal encapsulation of the cylinder as a heat shield. This would allow controlling the temperature of the measured liquid. In this arrangement the light source, the focusing screen, or both are placed outside of the cylinder and outside of the heat shield, as indicated in FIG. 5.

In a further embodiment, the horizontal rotatable cylinder is mounted on rollers, as shown in FIG. 5, or it is encapsulated in bearings or it is placed on a sliding surface.

In a further embodiment, the proposed device measures viscoelastic properties of some other materials, especially of liquids with impurities, liquids with some inhomogeneities, liquids with dirt particles, liquids with nanoparticles, or similar.

The meaning of the term “optical focusing screen” comprises any device with the function of collecting the focused image with or without the possibly recording this image, like a simple screen, a screen with an electronic camera, a CCD sensor, a CMOS sensor, a quadrant photodiode, a position sensing detector (PSD), or a camera with a suitable optics.

The meaning of “horizontal cylinder” is not restricted to the definition of a mathematical cylinder shape. It shall enclose any similar shape with the function as described for the cylinder above.

The meaning of “viscoelastic properties” comprises “viscosity” for Newtonian liquids as a special case.

The term “comprising” whenever used in this document is intended to indicate the presence of stated features, integers, steps, components, but not to preclude the presence or addition of one or more other features, integers, steps, components or groups thereof.

The disclosure is of course not in any way restricted to the embodiments described and a person with ordinary skill in the art will foresee many possibilities to modifications thereof without departing from the basic idea of the disclosure as defined in the appended claims.

The above described embodiments are obviously combinable.

The following dependent claims set out particular embodiments of the disclosure.

The following reference is hereby incorporated in its entirety.
[1] J. Sanders, D. D. Joseph and G. S. Beavers, Rimming Flow of a Viscoelastic Liquid Inside a Rotating Horizontal Cylinder, Journal of Non-Newtonian Fluid Mechanics, 9 (1981) 269-300.

1. Device for viscosity or viscoelasticity measurement comprising:
a structure comprising a horizontal rotatable cylinder-shaped section for receiving a liquid whose viscosity or viscoelasticity is to be measured;
a light source arranged for emitting light onto a surface of the liquid when in rotation within said structure;
an optical focusing screen arranged at an end of said cylinder-shaped section;
an optical sensor for detecting a light spot, emitted by the light source and reflected by the liquid surface in rotation within the structure, impinging on the optical focusing screen;
an electronic data processor arranged for calculating the viscosity or viscoelasticity of the liquid from the location of said light spot on said optical focusing screen;
wherein an inner surface of said structure optionally comprises and antioxidant and/or antimicrobial coating.

2. Device according to claim 1, wherein said structure is placed lengthwise between the light source and the optical screen.

3. Device according to claim 1, wherein the light source is movable for adjusting the light path during the measurement, optionally comprising a light block for avoiding the light emitted by the light source to impinge directly on the optical screen.

4. Device according to claim 1, wherein the screen is an optical focusing screen, preferably a screen with a camera, more preferably an electronic camera, a CCD sensor, a CMOS sensor, a quadrant photodiode or a position sensing detector (PSD).

5. (canceled)

6. (canceled)

7. Device according to claim 1, further comprising a concave lens in front of the optical focusing screen for amplification of the optical signal.

8. Device according to claim 1, wherein the light source is selected from the following list: incandescent lamp, compact fluorescent lamp, halogen lamp, metal halide lamp, light emitting diode, fluorescent tube, neon lamp, high intensity discharge lamp, low-pressure sodium lamp and diode laser, preferably a miniature diode laser with a concave or convex expanding lens.

9. Device according to claim 1, wherein said structure is made of poly(methyl methacrylate), ceramics, glass, hard plastic, steel or combinations thereof.

10. Device according to claim 1, said structure has an inner diameter from 40 mm to 300 mm, preferably from 60 mm to 150 mm, particularly 64 mm.

11. Device according to claim 1, wherein said structure has an outer diameter from 50 mm to 320 mm, preferably from 65 mm to 150 mm, particularly 70 mm.

12. Device according to claim 1, wherein said structure has a length from 30 to 1000 mm, preferably from 100 mm to 200 mm, particularly 150 mm.

13. Device according to claim 1, further comprising an outer case around the horizontal rotatable cylinder for maintaining the temperature during viscosity or viscoelasticity measurement wherein the outer case is preferably a heat shield.

14. (canceled)

15. Device according to claim 1, further comprising a supporting structure, particularly a rolling structure comprising a, roller or a plurality of rollers or a fixed structure.

16. (canceled)

17. Device according to claim 15, wherein the supporting structure comprises a bearing or a plurality of bearings.

18. Device according to claim 17, wherein the supporting structure comprises ball bearings around the horizontal cylinder, sliding bearings, or a plurality of bearings supporting the horizontal cylinder.

19. Method of manufacture of a device comprising the step of providing a device according to claim 1.

20. Method for measuring viscosity or viscoelasticity of a liquid comprising the following steps:
placing a light source arranged at a first end of said structure for emitting light onto the liquid surface in rotation within the structure;
placing an optical focusing screen arranged at a second end of said structure;
introducing a liquid in a structure comprising a horizontal rotatable cylinder-shaped section;
rotating said structure at a speed such that a quasi-cylindrical surface of liquid is formed;
detecting a light spot, emitted by the light source and reflected by the liquid surface in rotation within said structure, impinging on the optical focusing screen;
calculating the viscosity or viscoelasticity of the liquid from the location of said light spot on said optical focusing screen.

21. Method according to the claim 20 comprising the steps of:
detecting multiple light spots or a multiple light-spot image, emitted by the light source and reflected by the liquid surface in rotation within said structure, impinging on the optical screen;
calculating the viscosity or viscoelasticity of the liquid from the location of said light spots or said multiple light spots on the image on said optical screen.

22. Method for measuring viscosity or viscoelasticity of a liquid according to claim 20 comprising the following steps:
placing a light source arranged at a first end of said structure for emitting light onto the liquid surface in rotation within the structure;
placing an optical focusing screen arranged at a second end of said structure;
introducing a first liquid in a structure comprising a horizontal rotatable cylinder-shaped section;
introducing a second liquid in said structure such that the horizontal rotatable cylinder is completely filled;
rotating said structure at a speed such that a quasi-cylindrical surface between the first liquid and second liquid is formed;
detecting a light spot, emitted by the light source and reflected by the surface between the first liquid and second liquid in rotation within said structure, impinging on the optical focusing screen;
calculating the viscosity or viscoelasticity of the first liquid from the location of said light spot on said optical focusing screen;
optionally detecting multiple light spots or a multiple light spot image, emitted by the light source and reflected by the surface between the first liquid and second liquid in rotation within said structure, impinging on the optical screen;
calculating the viscosity or viscoelasticity of the liquid from the location of said light spots or said multiple light spots on the image on said optical screen.

23. (canceled)

24. Method according to claim 20 wherein the calculation is performed on an electronic data processor.

25. Method according to claim 20 wherein the liquid is selected from the following list: liquid with no impurities, liquid with impurities, liquid with inhomogeneities, liquid with dirt particles, liquid with nanoparticles and mixtures thereof.
